(19) United States
(12) Patent Application Publication
(10) Pub. No.: US 2026/0206775 A1
(43) Pub. Date: Jul. 23, 2026

(54) PREPARATION OF FOOD

(71) Applicant: FOXIMVO, INC, Dover, DE (US)

(72) Inventor: Rudolf Roelf VOS, Durbanville (ZA)

(21) Appl. No.: 19/142,145

(22) PCT Filed: Aug. 23, 2023
(86) PCT No.: PCT/IB2023/058477

§ 371 Date: Jun. 20, 2025

Related U.S. Application Data
(60) Provisional application No. 63/476,933, filed on Dec. 22, 2022.

(51) Int. Cl. A23B 4/052; A23L 27/27; A23L 29/256; A23L 29/281

(52) U.S. Cl. CPC A23B 4/0526; A23L 27/27; A23L 29/256; A23L 29/284

(57) ABSTRACT

A food flavouring product for flavouring food while it is prepared by the application of heat to the food inside an enclosed cooking space (i.e. while the food is being cooked inside the cooking space) is provided. The product comprises a hollow body of a heat-resistant material, defining an interior space. The product also comprises at least one outlet aperture granting fluid access to and egress from the interior space, defined in the body. The product further comprises a liquid or liquid-based flavouring agent, comprising liquid smoke or a liquid smoke component, contained inside of the interior space.

### FIELD OF THE INVENTION

THIS INVENTION relates to the preparation of food, specifically by the application of heat to the food to cook the food, e.g. by means of grilling, baking, roasting, or air frying. More specifically, the invention relates to the preparation of flavoured food, wherein a flavour is applied to food while the food is being prepared by the application of heat to the food. The invention provides a food flavouring product. The invention also provides a method of preparing flavoured food using the food flavouring product.

### BACKGROUND TO THE INVENTION

FLAVOURING OF FOOD, while the food is being prepared by the application of heat to the food, is a common practice which takes numerous forms. Generally speaking, popular approaches to effect such flavouring include basting and smoking, both of which are most commonly, although not exclusively, applied to the preparation of meat.

Basting involves the application of a flavoured liquid, such as a sauce, directly to the food that is being prepared by the application of heat to the food, while the food is being prepared by the application of heat to the food, although there may also be at least some application of the flavoured liquid before preparation commences.

Smoking involves exposing food that is being prepared, by the application of heat to the food, to smoke from burning or smouldering material, such as wood or wood chips, while the food is being prepared.

An alternative to smoking that approximates the taste of smoking but avoids the need to use smoke, is to baste or spray food that is being prepared, by the application of heat to the food, with a liquid substance known as “liquid smoke”. There is also a practice called “smoke flavouring” which involves treating foods with flavourings produced by pyrolysis, typically by mixing such flavourings with traditional food products.

Liquid smoke is a natural product originating from the burning of wood.

More specifically, the burning of wood produces, in addition to smoke, water in the form of vapour This vapor, when condensed by passing it through cooled tubing in the presence of smoke, captures the smoke and, thus, the flavour of the smoke. This liquid is then distilled into a concentrate and is filtered of its impurities (including soot and ash), thus producing liquid smoke in the form of a yellow-brown liquid substance.

Basting food with any form of basting liquid is often associated with extensive loss of basting liquid. Furthermore, basting often forms lumps or pools of excessive basting liquid on food that is being prepared by the application of heat to the food. This tends to result in a prepared food product being produced that has areas of burnt basting liquid thereon.

The present invention seeks to provide an alternative approach to the flavouring of food using liquid smoke.

### SUMMARY OF THE INVENTION

ACCORDING TO ONE ASPECT OF THE INVENTION IS PROVIDED a food flavouring product for flavouring food while it is prepared by the application of heat to the food inside an enclosed cooking space (i.e. while the food is being cooked inside the cooking space), the product comprising
a hollow body of a heat-resistant material, defining an interior space;
at least one outlet aperture granting fluid access to and egress from the interior space, defined in the body; and
a liquid or liquid-based flavouring agent, comprising liquid smoke or a liquid smoke component, contained inside of the interior space.

Reference in this specification to an “enclosed cooking space” includes reference to cooking spaces of the type that are openable to grant operative access to the space, which therefore only becomes enclosed once closed, e.g. by a door (such as an oven door) or lid (such as a barbeque lid).

The term “product” is used in this specification in characterising the combination of the hollow body and the flavouring agent. In different terms, and thus as an alternative for the term “product”, the food flavouring product may alternatively be characterised as a food flavouring kit or food flavouring device or food flavouring agent delivery device or food flavouring dispensing device. As an alternative to the term “device”, the term “pod” may characterise the nature of the product in more detail.

The flavouring agent may be in liquid format, optionally thickened liquid format, or may be in the form of an artefact comprising solidified liquid. For example, the flavouring agent may be in the form of a gel.

Thickening of solidification of the flavouring agent may have been effected by including a thickening or solidification agent in the flavouring agent. Substances, i.e. thickening or solidification agents, that may be employed to thicken or solidify the flavouring agent may include, for example, gelatine and agar.

Advantageously, when in a thickened or solidified format as opposed to non-thickened liquid format, the flavouring agent may be prevented from escaping or being lost from the interior of the body through the outlet aperture, instead being retained within the interior of the body for conversion of at least the liquid smoke component of the flavouring agent to a vapour form as hereinafter described.

In addition, when the flavouring agent is in a thickened or solidified format, transport of the product would also be facilitated, in that risk of loss of flavouring agent from the interior space would be minimised or avoided.

The heat-resistant material may be selected such that the body maintains its structural integrity at temperatures above a temperature at which at least some of the flavouring agent, or more specifically at least some of the liquid smoke component thereof, would evaporate, i.e. at which the flavouring agent, or at least the liquid smoke component thereof, would be converted into a vapour form. Such a temperature may, in some cases, be in the region of from about 90° C. to about 120° C., but higher temperatures are envisaged, depending on cooking conditions. For example, the heat-resistant material may be selected such that the body maintains its structural integrity at temperatures up to 350° C. or more.

The heat-resistant material should, however, also be sufficiently heat conductive for the flavouring agent, while contained inside the interior space, to be sufficiently heated such that at least some of the flavouring agent, or more specifically at least some of the liquid smoke component thereof, would in use be converted into a vapour form, i.e. is evaporated through the application of heat to the body.

In one embodiment of the invention, the heat-resistant material may be aluminium.

It will be appreciated that, in use, conversion of at least some of the flavouring agent, or at least some of the liquid smoke component thereof, into a vapour form inside of the interior space of the body would, as a desired consequence, not necessarily immediately, but eventually, once pressure inside the interior space has sufficiently increased as a result of the evaporation, escape from the interior space through the outlet aperture, thus being discharged from the interior space.

Such discharge of flavouring agent and, more specifically, of liquid smoke, in vapour form, from the interior space of the body, would, subject to appropriate positioning of the body inside of the cooking space, bring such liquid smoke in vapour form into physical contact with food that is prepared in the cooking space by the application of heat to the food, thus imparting a flavour to (i.e. flavouring) the food.

The flavouring agent may comprise an evaporation enhancing substance, to enhance evaporation of at least some of the flavouring agent and, more specifically, of at least some of the liquid smoke component thereof.

The body may have a maximum dimension that allows it to be accommodated inside of the cooking space without unduly limiting the space that is available for concurrent cooking of food inside of the cooking space. It will thus be appreciated that the product is, in a preferred embodiment of the invention, a discrete product that is removably, and typically loosely, locatable inside and removable from an enclosed cooking space. Although not excluded from the scope of the invention, it is typical that the product would not be mounted inside the cooking space, e.g. by means of fixed mountings that fixes its position inside the cooking space. Rather, the product would in use simply be placed or, put differently, “put down” at a selected location inside the cooking space.

Typically, the body may have a maximum dimension of a few centimetres, e.g. less than about 30 cm, more specifically less than about 20 cm, more specifically less than about 10 cm, e.g. between about 1 cm and about 10 cm, such as 5 cm.

The body may have a volume, provided by its interior space, of about 10 ml to about 25 ml, e.g. about 15 ml. However, depending on the size of the cooking space, a possibility for the larger volumes is envisaged, e.g. for the body to have a volume of up to about 200 ml.

The outlet aperture may have a diameter of between about 0.4 mm and about 3 mm, e.g. about 1 mm.

The diameter of the aperture may be selected for a predetermined rate of release of the flavouring agent through evaporation thereof, in use. In this regard, it will be appreciated that a larger aperture would encourage faster release of flavouring agent.

The outlet aperture may in one embodiment of the invention be defined by a nozzle that projects from the body.

It will be appreciated that it is in accordance with the invention for the body to have more than one outlet aperture defined therein, and embodiments of the invention in which two or more outlet apertures, optionally defined by respective nozzles, are provided in the body, are within the scope of the invention.

It is also within the scope of the invention that the aperture may simply be a mouth of the body, e.g. defined by a perimeter wall of the body. Thus, whereas an aperture in the strict sense of the term, and within the scope of the present invention, in one embodiment envisages a small hole defined in a surface by surrounds of the aperture, supplied by the surface, an aperture in the context of the present invention may also include a larger opening, defined for example by a perimeter wall of the body. The embodiment provided by the strict interpretation of the term is more preferred, however.

The outlet aperture may be covered with a removable cover, such as a lid or a removable label, to be removed before use. Another alternative is for the outlet aperture to be covered with a heat-removable seal, e.g. a wax seal, that melts away upon application of heat.

The product may exclude any internal or integrated heating means. Thus, in use, heat required to evaporate the flavouring agent may be supplied exclusively by a heat source that supplies heat to the enclosed cooking space.

ACCORDING TO ANOTHER ASPECT OF THE INVENTION THERE IS PROVIDED a method of preparing flavoured food, the method including
applying heat to food inside an enclosed cooking space; and
locating a food flavouring product inside the cooking space, wherein the food flavouring product comprises
   a hollow body of a heat-resistant material, defining an interior space;
   at least one outlet aperture granting fluid access to and egress from the interior space, defined in the body; and
   a liquid or liquid-based flavouring agent, comprising liquid smoke or a liquid smoke component, contained inside of the interior space.
wherein the body of the food flavouring product, and thus the food flavouring agent that it contains, is heated by the heat that is applied to the food, thereby causing a least some of the flavouring agent, and more specifically at least some of the liquid smoke component thereof, to be converted into a vapour form inside of the interior space defined by the body and to be discharged from the interior of the body, into the cooking space and thus into contact with the food, thus flavouring the food inside the cooking space while the food is being prepared by the application of heat to the food.

The food flavouring product may, in particular, be a food flavouring product according to the invention.

The food flavouring product may be located inside the cooking space such that liquid smoke in vapour form that is discharged from the body physically contacts the food inside the enclosed cooking space.

The food may, in particular, be animal meat and, more specifically, one or more cuts of animal meat, which may include, for example, chicken meat, fish meat, beef meat, game meat, lamb meat, veal, and meat variables/replacements. Alternatively, the food may be a bakeable substance, i.e. comprising dough or another bakeable substance that is baked to produce baked goods such as bread or cake by the application of heat to it. Alternatively, the food may be a vegetable, such as potato, cauliflower, etc.

The application of heat may be through use of fire, coals, gas, electricity, or heated air, for example involving grilling, roasting, baking, or air frying.

The cooking space may be provided by a cooking device, which may for example be an oven, a barbeque, an air fryer, a griller, a convection oven, a stovetop pot or pan, etc.

### DETAILED DESCRIPTION OF AN EMBODIMENT

THE INVENTION IS NOW DESCRIBED IN MORE DETAIL with reference to a non-limiting example thereof, as illustrated in the accompanying diagrammatic drawings.

In the drawings,

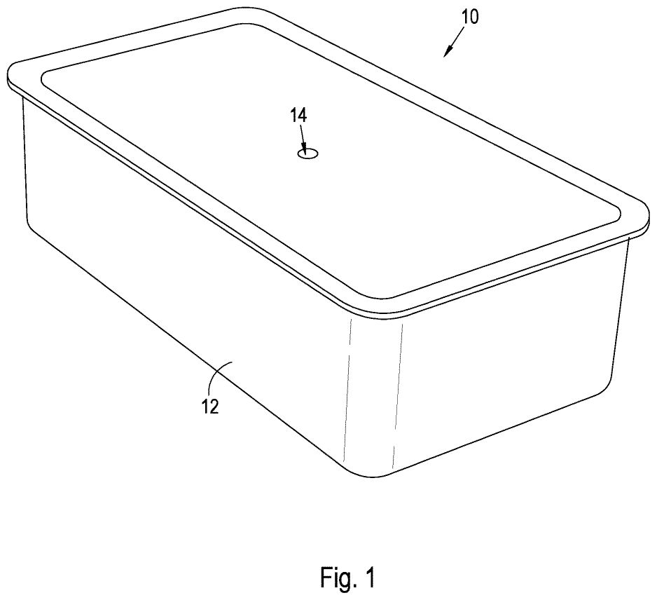

FIG. 1 shows a three-dimensional view of one embodiment of a food flavouring product according to the invention;

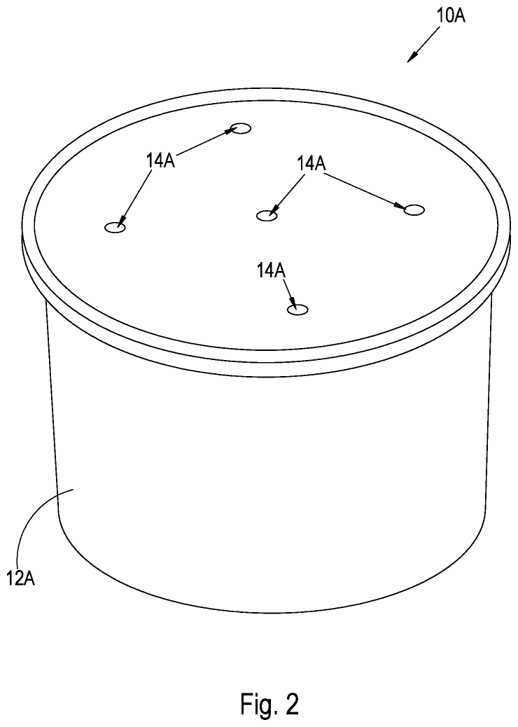

FIG. 2 shows a three-dimensional view of another embodiment of a food flavouring product according to the invention;

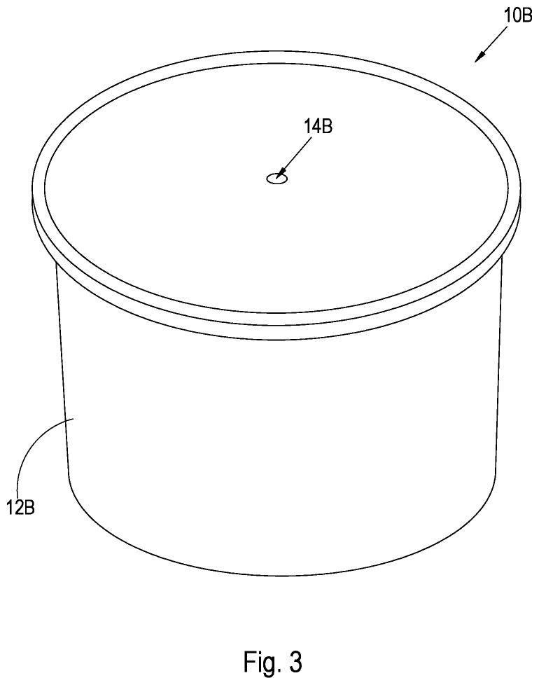

FIG. 3 shows a three-dimensional view of yet another embodiment of a flavouring product according to the invention;

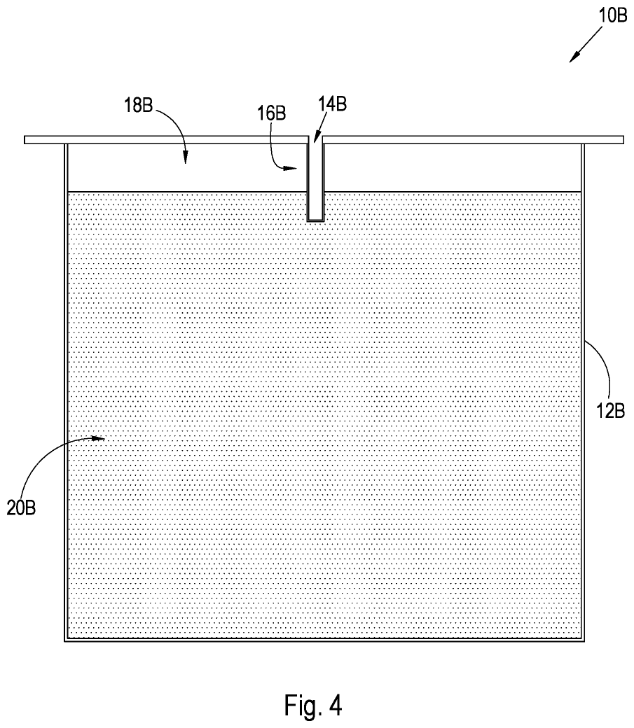

FIG. 4 shows one embodiment of the food flavouring product according to the invention of FIG. 3 in sectional view;

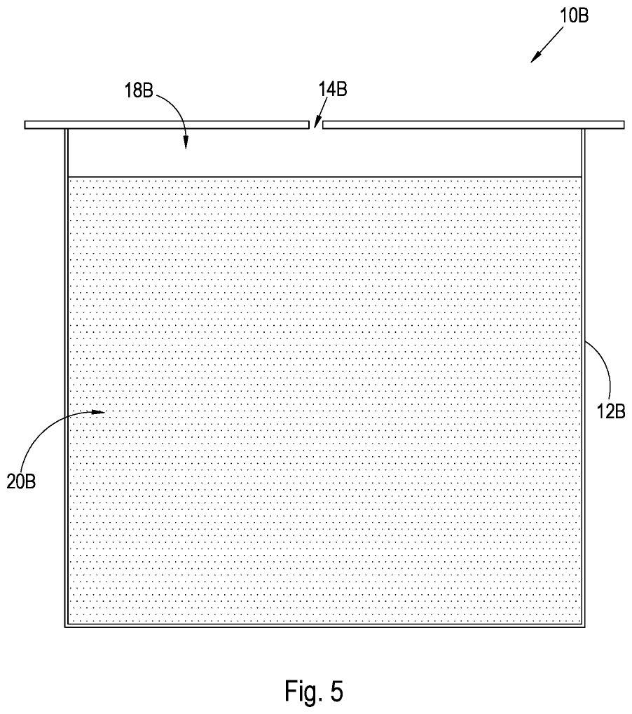

FIG. 5 shows another embodiment of the food flavouring product according to the invention of FIG. 3 in sectional view;

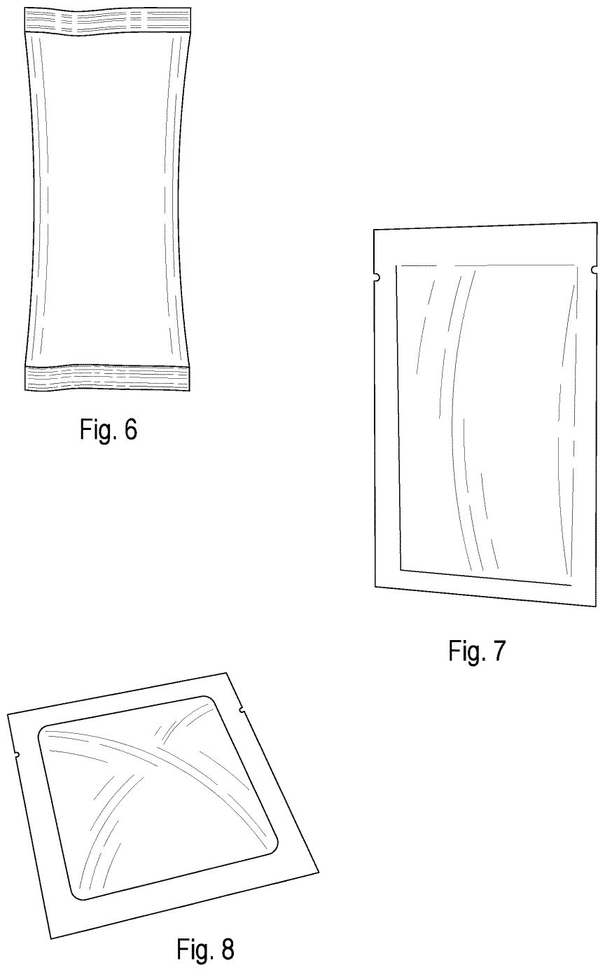

FIGS. 6 to 8 show further alternative embodiments of food flavouring products according to the invention;

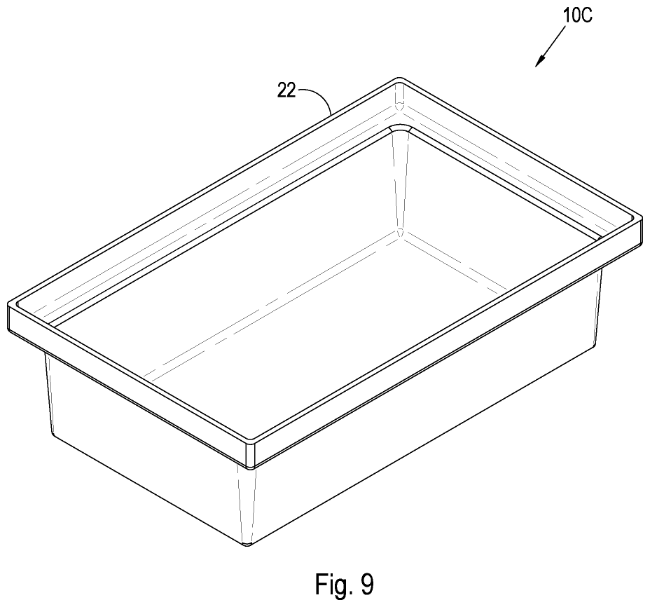

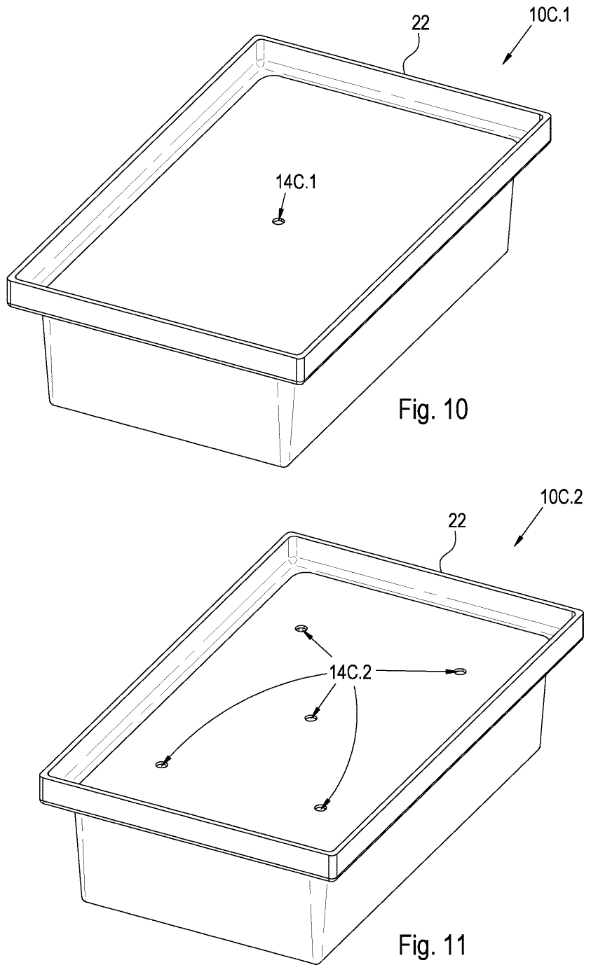

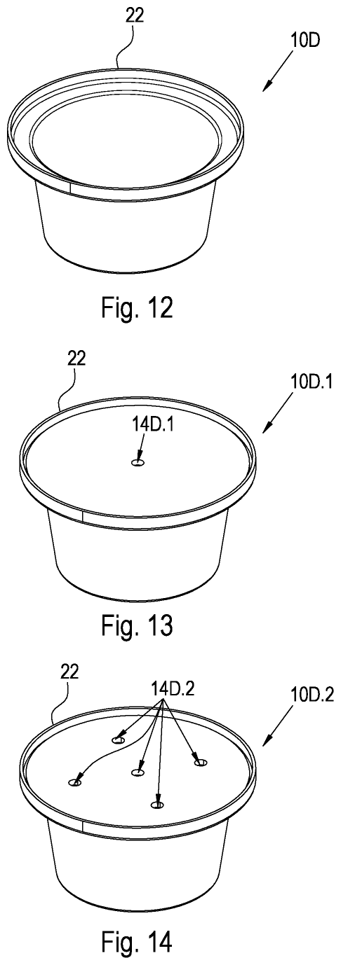

FIGS. 9 to 11 show yet another alternative embodiment of a food flavouring product according to the invention; and FIGS. 12 to 14 show still a further alternative embodiment of a food flavouring product according to the invention.

Referring to the drawings, and in particular to FIG. 1, reference numeral 10 generally shows one embodiment of a food flavouring product according to the invention.

The product 10 comprises a rigid hollow body 12 of a heat-resistant material that defines an interior space (not visible). The body 12 is therefore hollow.

An aperture 14, granting fluid access to and egress from the interior space, is defined in the body 12. The aperture 14 may, prior to use, be closed by a removable cover, e.g. a lid, which may in one embodiment of the invention be adhesively attached to the body to close the aperture 14. Another alternative, in accordance with he invention, may be to use a wax seal that melts away when heated.

While also not visible in FIG. 1, a liquid or liquid-based flavouring agent, comprising liquid smoke or a liquid smoke component, is contained inside of the interior space that is defined by the body 12. In accordance with the invention, the flavouring agent may be in a liquid format, or in a solidified liquid format, e.g. in the form of a gel.

FIG. 2 and FIG. 3 respectively illustrate alternative embodiments of the product of FIG. 1, in which the same reference numerals used in FIG. 1 are used to indicate parts of common function between the products, with the addition of suffix “A” in respect of the embodiment of FIG. 2 and suffix “B” in respect of the embodiment of FIG. 3.

FIG. 4 shows a sectional view of one configuration of the product 10B of FIG. 3. As will be seen, the aperture 14B of the product 10B in the embodiment illustrated in FIG. 4 attaches to a channel formation 16B that extends into the interior 18B of the body 12B, and also into the liquid or liquid-based flavouring agent 20B that is contained inside the interior 18B.

In FIG. 5, an alternative configuration of the product 10B of FIG. 3 is shown, in which no channel-defining formation 16B is provided, and the body 12B therefore merely includes the aperture 14B.

The abovementioned configurations of the product 10B of FIG. 3, as illustrated in FIGS. 4 and 5, may be applied equally to the embodiments 10 and 10A of the product illustrated in FIGS. 1 and 2 respectively.

Referring to FIGS. 6 to 8, it is within the scope of the invention that, instead of the product of the invention comprising a rigid body, such as the bodies 12, 12A and 12B of the embodiments of the product of the invention illustrated in FIGS. 1 to 3, the body may be of a flexible material, such that the product of the invention is provided as a sachet, as illustrated in FIGS. 6 to 8.

FIGS. 9 to 14 show two further embodiments 10C, 10D of the product of the invention, each embodiment, in turn, having two possible embodiments 10C.1, 10C.2 and 10D.1, 10D.2.

In addition to the features shared with the other embodiments 10, 10A and 10B of the product of the invention, which are designated with reference numerals corresponding to those of FIGS. 1 to 5, the embodiments 10C and 10D of the product of the invention each has a circumferential, or peripheral, edge portion 22. The aperture/s 14C.1, 14C.2, 14D.1, 14D.2 are thus located in a sunken position relative to a top of the edge portion 22.

In use, the edge portion 22 would prevent flavouring agent that is discharged from the aperture/s 14C.1, 14C.2, 14D.1, 14D.2 and that condenses on a top of the product, from running onto food that is being flavoured using the product, thus avoiding over-flavoured spots from forming on the food.

### DISCUSSION

THE INVENTOR of the present invention is aware of the existence of devices exploiting liquid smoke for the flavouring of food, including liquid smoke regenerators that seek to evaporate liquid smoke into a cooking space.

In the inventor's experience, such devices are, however, generally complicated in nature, being incorporated into cooking devices. Therefore, such devices do not provide a solution to persons seeking to flavour food using liquid smoke in a device that is not properly configured, otherwise than to apply liquid smoke in a liquid form to food that is cooked in a cooking device.

The present invention seeks to address this need, and thereby enable the flavouring of food through the evaporation of liquid smoke in devices not adapted for such application of liquid smoke.

1. A method of preparing flavoured food, the method including:
applying heat to food inside an enclosed cooking space; and
locating a food flavouring product inside the cooking space, wherein the food flavouring product comprises:
a hollow body of a heat-resistant material, defining an interior space;
at least one outlet aperture granting fluid access to and egress from the interior space, defined in the body; and
a liquid or liquid-based flavouring agent, comprising liquid smoke or a liquid smoke component, contained inside of the interior space;
wherein the body of the food flavouring product, and thus the food flavouring agent that it contains, is heated by the heat that is applied to the food, thereby causing a least some of the flavouring agent, and more specifically at least some of the liquid smoke component thereof, to be converted into a vapour form inside of the interior space defined by the body and to be discharged from the interior of the body, into the cooking space and thus into contact with the food, thus flavouring the food inside the cooking space while the food is being prepared by the application of heat to the food.

2. The method according to claim 1, wherein the food flavouring product is located inside the cooking space such that liquid smoke in vapour form that is discharged from the body, physically contacts the food inside the enclosed cooking space.

3. The method according to claim 1, wherein the enclosed cooking space is provided by a cooking device.

4. The method according to claim 3, wherein the cooking device is selected from the group consisting of: an oven, a barbeque device, and an air fryer.

5. A food flavouring product for flavouring food while it is prepared by the application of heat to the food inside an enclosed cooking space, the product comprising:
a hollow body of a heat-resistant material, defining an interior space;
at least one outlet aperture granting fluid access to and egress from the interior space, defined in the body; and
a liquid or liquid-based flavouring agent, comprising liquid smoke or a liquid smoke component, contained inside of the interior space.

6. The food flavouring product according to claim 5, wherein the flavouring agent is in a format selected from the group consisting of:
liquid;
thickened liquid; and
an artefact comprising solidified liquid.

7. The food flavouring product according to claim 6, wherein the flavouring agent is thickened liquid or an artefact comprising solidified liquid, such thickening or solidification having been effected by including a thickening or solidification agent in the flavouring agent.

8. The food flavouring product according to claim 7, wherein the thickening or solidification agent is selected from gelatine and agar.

9. The food flavouring product according to claim 5, wherein the heat-resistant material is aluminium.

10. The food flavouring product according to claim 5, wherein:
the body has a maximum dimension less than about 30 cm, or less than about 20 cm, or less than about 10 cm, or between about 1 cm and about 10 cm, or that is 5 cm;
the body has a volume, provided by its interior space, of up to 200 ml, or from about 10 ml to about 25 ml, or of about 15 ml; and
the outlet aperture has a diameter of between about 0.4mm and about 3 mm, or of about 1 mm.
